(19) United States
(12) Patent Application Publication
(10) Pub. No.: US 2012/0286750 A1
(43) Pub. Date: Nov. 15, 2012

(54) SWITCHING REGULATORS WITH ADAPTIVE CLOCK GENERATORS AND ASSOCIATED METHODS OF CONTROL

(76) Inventor: Peng Xu, San Jose, CA (US)

(21) Appl. No.: 13/104,855

(22) Filed: May 10, 2011

(51) Int. Cl. G05F 1/10

(52) U.S. Cl. 323/282

(57) ABSTRACT

Various embodiments of switch mode power supplies, circuits, and methods of control are described herein. In one embodiment, a method of operating a switch mode power supply having a switching circuit coupled to an inductor includes modulating a duty cycle of the switching circuit to charge the inductor using pulse width modulation, supplying an output voltage from the inductor to the load, performing a comparison between the output voltage and a reference voltage, and deriving an error signal based on the comparison between the output voltage and the reference voltage. The method also includes generating a clock signal for the pulse width modulation based on the received error signal.

### TECHNICAL FIELD

The present disclosure is related generally to switching converters with adaptive clock signal generators and associated methods of control.

### BACKGROUND

Constant-frequency pulse-width-modulation (“PWM”) switching regulators are often used as point-of-load (“POL”) regulators to power processors, input/output logic chips, memories, and/or other digital electronic components. Constant-frequency PWM switching regulators have higher power conversion efficiencies and increased design flexibilities when compared to other types of regulators. For example, multiple output voltages of different polarities may be generated with such switching regulators based on a single input voltage.

Most constant-frequency PWM switching regulators perform satisfactorily at a steady state. However, power management of digital electronic components has become more comprehensive with ever decreasing control thresholds. As a result, transient performance requirements on the POL regulators have become more stringent. Conventional control topologies for addressing transient performance of POL regulators are typically based on variable frequency or pseudo-constant frequency techniques, which may be incompatible with fixed-frequency components and/or systems. Accordingly, several improvements to POL regulators for improving transient performance while maintaining fixed frequency operation at a steady state may be desirable.

### BRIEF DESCRIPTION OF THE DRAWINGS

FIG. 1 is a schematic circuit diagram of a PWM switching regulator in accordance with embodiments of the present technology.

FIG. 2 is a voltage versus time plot illustrating an error signal and a clock signal during a transient condition in accordance with embodiments of the present technology.

FIGS. 3-5 are schematic circuit diagrams of an oscillator suitable for use in the PWM switching regulator of FIG. 1 in accordance with embodiments of the present technology.

FIG. 6 is a schematic circuit diagram of a multi-phase PWM switching regulator in accordance with embodiments of the present technology.

### DETAILED DESCRIPTION

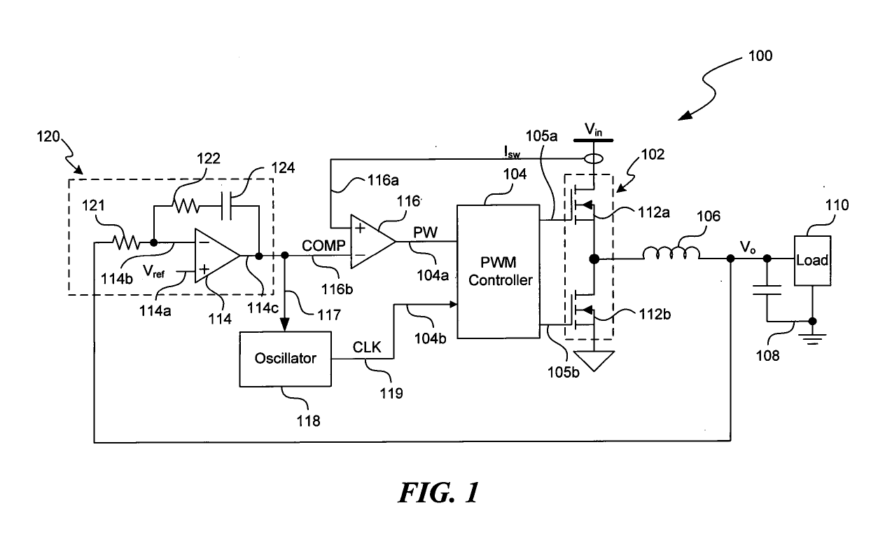

Various embodiments of switch mode power supplies, circuits, and methods of control are described below. Many of the details, dimensions, angles, shapes, and other features shown in the figures are merely illustrative of particular embodiments of the technology. A person skilled in the relevant art will also understand that the technology may have additional embodiments, and that the technology may be practiced without several of the details of the embodiments described below with reference to FIGS. 1-6.

FIG. 1 is a schematic circuit diagram of a PWM switching regulator 100 in accordance with embodiments of the present technology. In the following discussion, the PWM switching regulator 100 is described as a current-mode PWM buck converter. However, in other embodiments, the switching regulator 100 can also be a voltage-mode and/or other suitable types of PWM switching regulator. In further embodiments, the PWM switching regulator 100 can also be configured as a boost converter, a buck-boost converter, and/or can have other suitable configurations.

In the illustrated embodiment in FIG. 1, the PWM switching regulator 100 includes a switching circuit 102, a PWM controller 104, an oscillator 118, a voltage feedback circuit 120, a current comparator 116, an inductor 106, a capacitor 108, and a load 110 (e.g., a CPU) operatively coupled together. For example, the capacitor 108 and the load 110 are coupled in parallel between an output voltage (Vₒ) of the inductor 106 and the ground. Even though only the foregoing particular components are shown in FIG. 1, in other embodiments, the PWM switching regulator 100 can also include additional and/or different components.

As shown in FIG. 1, the switching circuit 102 includes a first switch 112a (commonly referred to as the high-side switch) and a second switch 112b (commonly referred to as the low-side switch) coupled in series between an input voltage (Vᵢₙ) and the ground. The first switch 112a has a source coupled to the input voltage (Vᵢₙ) and a drain coupled to both the second switch 112b and the inductor 106. The second switch 112b includes a source coupled to the drain of the first switch 112a and a drain coupled to the ground. The first and second switches 112a and 112b each include a gate coupled to a first output 105a and a second output 105b of the PWM controller 104, respectively. The first and second switches 112a and 112b can individually include a metal oxide field-effect transistor (“MOSFET”), a junction gate field-effect transistor (“JFET”), and/or other suitable types of transistor.

The PWM controller 104 is configured to controllably turn on/off the first and second outputs 105a and 105b to control a duty cycle of the first and second switches 112a and 112b based on the output voltage (Vₒ) of feedback of the inductor 106 and a switch current (I_{sw}) through the first and second switches 112a and 112b. As shown in FIG. 1, the PWM controller 104 includes a first input 104a and a second input 104b. The first input 104a is coupled to the current comparator 116 to receive a control input. The second input 104b is coupled to an oscillator output 119 from the oscillator 118 to receive a clock signal (generally designated as “CLK”).

The voltage feedback circuit 120 is configured to generate an error signal (generally designated as “COMP”) corresponding to a difference between the output voltage (Vₒ) of the inductor 106 and a reference voltage (V_{ref}). The voltage feedback circuit 120 is also configured to provide the error signal COMP to both the oscillator 118 and to the current comparator 116. In the illustrated embodiment, the voltage feedback circuit 120 includes a voltage comparator 114 with a first terminal 114a coupled to the reference voltage (V_{ref}) and a second terminal 114b, a current limiting resistor 121 coupled between the output voltage (Vₒ) and the second terminal 114b, a feedback capacitor 124 and a feedback resistor 122 coupled in series between an output terminal 114c and the second terminal 114b of the voltage comparator 114. In other embodiments, certain components of the voltage feedback circuit 120 (e.g., the feedback capacitor 124) may be omitted. In further embodiments, the voltage feedback circuit 120 may include additional and/or different components.

The current comparator 116 is configured to compare the sensed switch current (I_{sw}) to the generated error signal COMP from the voltage feedback circuit 120 to generate a control signal (generally designated as “PW”). The current comparator 116 then provides the control signal PW to the PWM controller 104. In the illustrated embodiment of FIG. 1, the current comparator 116 includes a first terminal 116a coupled to the sensed switch current (I_{sw}) and a second terminal 116b coupled to the output terminal 114c of the voltage comparator to receive the error signal COMP. In other embodiments, the current comparator 116 may also include feedback resistors, capacitors, and/or other suitable components.

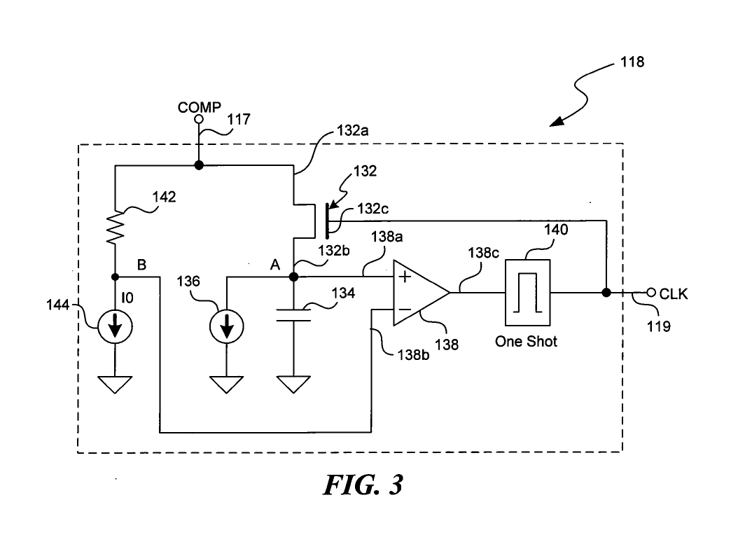

The oscillator 118 is configured to generate the clock signal CLK and provide the generated clock signal CLK to the PWM controller 104. In the illustrated embodiment, the oscillator 118 includes an oscillator input 117 coupled to the output terminal 114c of the voltage comparator 114 and an oscillator output 119 coupled to the second input 104b of the PWM controller 104. In other embodiments, the oscillator 118 may also be coupled to the sensed switch current (I_{sw}), other suitable components of the PWM regulator 100, and/or a combination thereof. Several embodiments of the oscillator 118 are described in more detail below with reference to FIGS. 3-5.

In operation, the PWM controller 104 alternately turning on the first and second switches 112a and 112b based on the clock signal CLK and the control signal PW. For example, at a rising edge of a pulse of the clock signal CLK, the PWM controller 104 turns on the first switch 112a to charge the inductor 106 and the capacitor 108 for a first period of time corresponding to the control signal PW. During the first period of time, the second switch 112b is turned off. After the first time period, the PWM controller 104 turns off the first switch 112a and turns on the second switch 112b to allow a current to freewheel around the inductor 106, the capacitor 108, and the second switching transistor 112b for a second period of time. The foregoing alternating operation is repeated to supply a target voltage level to the load 110.

Unlike conventional PWM devices in which the clock signal CLK has a fixed frequency at all times, embodiments of the PWM switching regulator 100 can include an oscillator 118 that is configured to generate a modulated clock signal CLK that is generally constant at a steady state but has a variable frequency during a transient state. As used hereinafter, the phrase “steady state” generally refers to a situation in which all variables of a system are generally constant with respect to time. The phrase “transient state” generally refers to a situation in which a variable of the system has been changed, and the system has not reached a steady state.

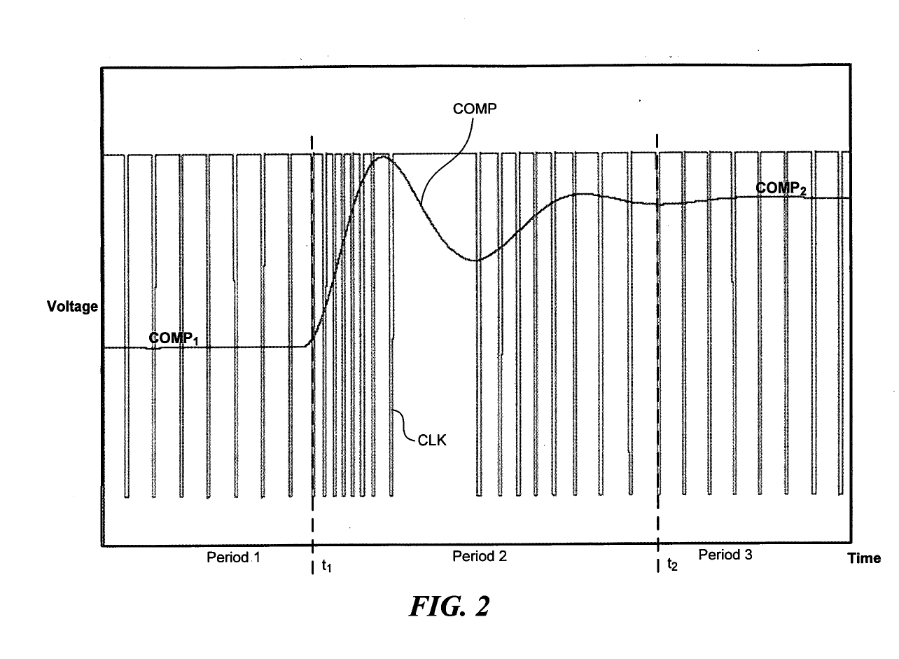

The modulated clock signal CLK with the varied frequency can facilitate a more rapid response to the transient condition, and thus improving transient performance of the PWM switching regulator 100. For example, FIG. 2 is a voltage versus time plot illustrating the error signal COMP and the clock signal CLK during a transient condition in accordance with embodiments of the present technology. As shown in FIG. 2, during a first stead state (generally designated as “Period 1”), the error signal COMP is generally constant with a first steady state value (COMP₁). As a result, the oscillator 118 (FIG. 1) generates a clock signal CLK with a generally fixed frequency corresponding to the generally constant error signal COMP.

At time t₁, a load increase occurs at the load 110 (FIG. 1) indicating a transient condition (generally designated as “Period 2”). As a result, the output voltage (Vₒ) of the inductor 106 (FIG. 1) decreases with time because of the increased demand from the load 110. As a result, the generated error signal COMP from the voltage feedback circuit 120 (FIG. 1) increases from the first steady state value COMP₁ and increases with time. In response to the increasing error signal COMP, the oscillator 118 generates a clock signal CLK with a higher frequency (as illustrated with the shorter periods in FIG. 2) while the current comparator 116 (FIG. 1) generates a control signal PW higher than those in the first steady state.

Based on the higher frequency clock signal and the control signal PW, the PWM controller 104 (FIG. 1) turns on the first switch 112a to charge the inductor 106 and the capacitor 108 with longer pulse widths and at higher frequencies than in steady state Period 1. The PWM controller 104 can also turns on the second switch 112b with shorter pulses and at higher frequencies. As a result, the output voltage (Vₒ) of the inductor 106 increases, and the error signal COMP decreases over time until a second steady state (generally designated as “Period 3”) is reached at time t₂. Because both the control signal PW and the clock signal CLK frequency increase over time, the output voltage (Vₒ) and the error signal COMP can reach the second steady state faster than in conventional devices, and thus improving transient performance of the PWM switching regulator 100. As shown in FIG. 2, the error signal COMP actually overshoot its second steady state value COMP₂.

Even though the oscillator 118 is discussed above as modulating the frequency of the clock signal CLK based on the error signal COMP from the voltage feedback circuit 120, in other embodiments, the oscillator 118 can also modulate the frequency of the clock signal CLK based on the sensed switch current (I_{sw}), other suitable operational parameters of the PWM regulator 100, and/or a combination thereof. In further embodiments, the oscillator 118 may be omitted. Instead, a leading edge of a data signal from the PWM controller 104 may be used as the clock signal, and the error signal COMP may be provided directly to the PWM controller 104 to modulate the lead edge of the data signal.

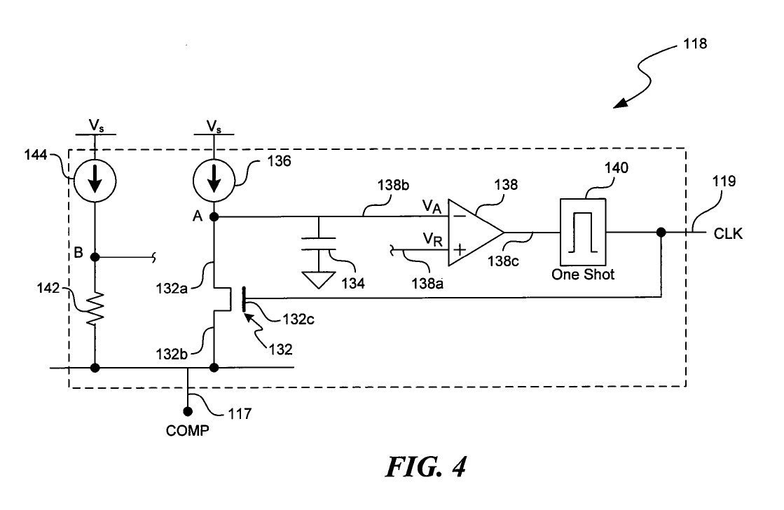

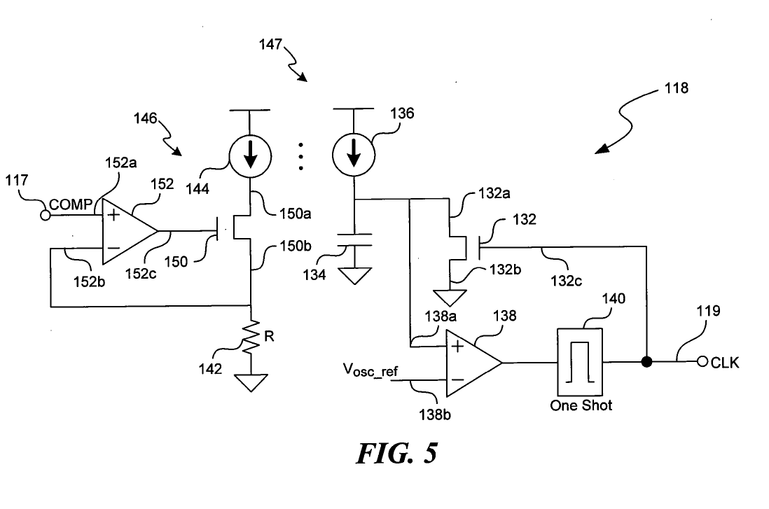

FIGS. 3-5 are schematic circuit diagrams of an oscillator 118 suitable for use in the PWM switching regulator of FIG. 1 in accordance with embodiments of the present technology. FIGS. 3 and 4 are directed to techniques of modulating the instantaneous period of the clock signal CLK by adjusting a charge/discharge voltage applied to an oscillation capacitor. FIG. 5 is directed to techniques of modulating the instantaneous period of the clock signal CLK by adjusting an oscillation current source for discharging the oscillation capacitor. Even though only particular embodiments of the oscillator 118 are illustrated with reference to FIGS. 3-5, one of ordinary skill in the relevant art will recognize that the oscillator 118 may have additional and/or different implementations based upon the following discussions.

FIG. 3 shows a first implementation, in which the oscillator 118 can include a charging switch 132, an oscillation capacitor 134, an oscillation current source 136, an oscillator comparator 138, an one-shot circuit 140, a divider resistor 142, and a resistor current source 144 operatively coupled to one another. The charging switch 132 has a source 132a, a drain 132b, and a gate 132c. The source 132a of the charging switch 132 is coupled to the error signal COMP at the oscillator input 117. The drain 132b of the charging switch 132 is coupled to (1) the oscillation capacitor 134, (2) the oscillation current source 136, and (3) a first input 138a of the oscillator comparator 138 at a junction node A. The gate 132c of the charging switch 132 is coupled to an output of the one-shot circuit 140. The charging switch 132 can include a MOSFET, a JFET, and/or other suitable types of solid state switch.

The divider resistor 142 is coupled in series with the resistor current source 144 between the error signal COMP and ground. As a result, a comparison signal that equals to a voltage at node B (V_{B}) of the oscillator 118 can be represented as follows:

V_{B}=V_{comp}−iR

where V_{cop} is a voltage at the oscillator input 117, R is a resistance of the divider resistor 142, and i is a current of the resistor current source 144.

The oscillation capacitor 134 and the oscillation current source 136 are in parallel to each other and coupled between the drain 132b of the charging switch 132 and ground. The oscillator comparator 138 has the first input 138a coupled to the drain 132b of the charging switch 132 at node A and a second input 138b coupled to the divider resistor 142 at node B. As a result, the oscillator comparator 138 compares the voltages at node A and node B (V_{A} and V_{B}, respectively) and provide an comparison result at a comparator output 138c to the one-shot circuit 140. In the illustrated embodiment, the first input 138a is a positive terminal, and the second input 138b is a negative terminal. In other embodiments, the first and second inputs 138a and 138b can have other suitable configurations.

In operation, an instantaneous frequency (or period) of the clock signal CLK at the oscillator output 119 relates to a discharging rate of the oscillation capacitor 134, and a value of the voltage at node B (V_{B}). Initially, the charging switch 132 is open or off. The oscillation current source 136 discharges the oscillation capacitor 134 until the oscillation capacitor 134 has a voltage (V_{capacitor}) equal to the voltage at node B (V_{B}). Once the voltage (V_{capacitor}) on the oscillation capacitor 134 is pulled below the voltage at node B (V_{B}), the oscillator comparator 138 causes the one-shot circuit 140 to provide a pulse that serves as a clock tick for the clock signal CLK. The pulse from the one-shot circuit 140 also turns on or close the charging switch 132 to charge the oscillation capacitor 134 to the error signal voltage (V_{COMP}), and the foregoing process repeats to generate a periodic clock signal CLK.

As shown above, the voltage at node B (V_{B}) depends on the voltage of the error signal (V_{COMP}). As a result, a sudden increase in the error signal voltage (V_{COMP}) also increases the voltage at node B (V_{B}). Thus, a shorter amount of time is required to pull the capacitor voltage (V_{capacitor}) below the voltage at node B (V_{B}) and to cause the oscillator comparator 138 to trip the one-shot circuit 140. Accordingly, the instantaneous period of the clock signal CLK can be shortened to facilitate improving transient performance of the PWM switching regulator 100 (FIG. 1).

Even though the oscillation capacitor 134 is charged with the error signal voltage (V_{COMP}) when the charging switch 132 is closed in FIG. 3, in other embodiments, the oscillation capacitor 134 may be charged with other suitable voltage sources (not shown). For example, in one embodiment, the oscillation capacitor 134 may be charged with a constant reference voltage (not shown). As discussed above, an increase in the error signal voltage (V_{COMP}) also increases the voltage at node B (V_{B}). A shorter amount of time is required to pull the capacitor voltage (V_{capacitor}) from the constant reference voltage below the voltage at node B (V_{B}). Thus, the instantaneous period of the clock signal CLK can be shortened.

FIG. 4 shows a second implementation, in which the voltage at node B (V_{B}) is higher than the error signal voltage (V_{COMP}). As shown in FIG. 4, the resistor current source 144 and the divider resistor 142 is coupled between a supply voltage (Vₛ) and the error signal voltage (T_{COMP}). As a result, the voltage at node B (V_{B}) can be determined as follows:

V_{B}=V_{COMP}+iR

The oscillation current source 136 is coupled to (1) the oscillation capacitor 134, (2) the source 132a of the charging switch 132, and (3) the second input 138b at junction node A. The drain 132b of the charging switch 132 is coupled to the error signal voltage (V_{COMP}). The oscillator 118 shown in FIG. 4 operates generally similarly as that shown in FIG. 3. As a result, operation of the oscillator 118 in FIG. 4 is omitted for clarity.

FIG. 5 shows a further implementation of the oscillator 118, in which the instantaneous period of the clock signal CLK is modulated by adjusting the oscillation current source 136. Unlike the embodiment of the oscillator 118 shown in FIG. 4, the second terminal 138b of the oscillation comparator 138 in FIG. 5 is coupled to a generally constant oscillation reference voltage.

As shown in FIG. 5, the oscillator 118 also includes a current setting circuit 146 having a current switch 150 and a current comparator 152. The current switch 150 has a source 150a coupled to the resistor current source 144 and a drain 150b coupled to the divider resistor 142. The current comparator 152 includes a first input 152a coupled to the error signal voltage (V_{COMP}), a second input 152b coupled to the divider resistor 142, and a gate 152c coupled to the gate 150c of the current switch 150. In operation, the current switch 150 is turned on when the voltage across the divider resistor 142 is equal to the error signal voltage (V_{COMP}). As a result, the error signal voltage (V_{COMP}) sets a current level through the divider resistor 142.

The current level set by the error signal voltage (V_{COMP}) can then be mirrored to the oscillator current source 136 via, for example, a current mirror 147 (shown schematically) and/or other suitable components. Thus, when the error signal voltage (V_{COMP}) increases, the discharge current from the oscillator current source 136 also increases, and thus resulting in a shortened instantaneous period (and higher frequency) for the clock signal CLK. When the error signal voltage (V_{COMP}) decreases, the discharge current from the oscillator current source 136 also decreases, and thus resulting in a lengthened instantaneous period (and lower frequency) for the clock signal CLK.

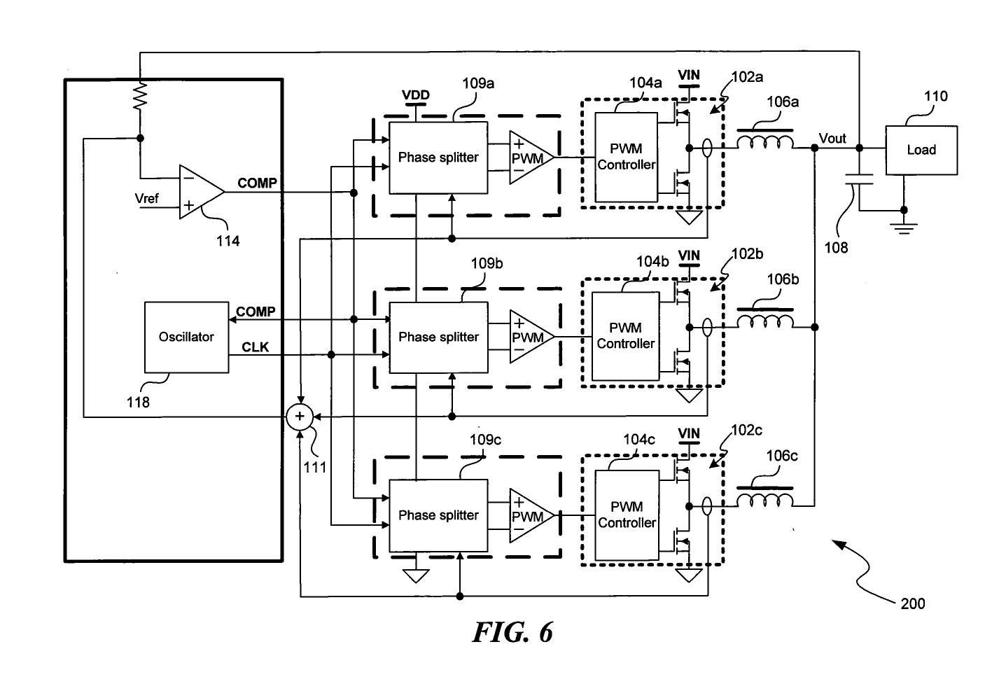

Even though the PWM switching regulator 100 in FIG. 1 is shown as a single phase regulator, the present technology can also be applied to multi-phase switching regulators. For example, FIG. 6 is a schematic circuit diagram of a three-phase PWM switching regulator 200 in accordance with embodiments of the present technology. As shown in FIG. 6, unlike the PWM switching regulator 100 of FIG. 1, the PWM switching regulator 200 includes first, second, and third phase splitters 109a, 109b, and 109c individually coupled to first, second, and third PWM controllers 104a, 104b, and 104c, switching circuits 102a, 102b, and 102c, and inductors 106a, 106b, and 106c. The individual phase splitters 109a, 109b, and 109c selectively enable the respective PWM controllers 104a, 104b, and 104c at different phases. Even though a three phase application is shown in FIG. 6, the present technology can also be applied to two-phase applications and/or other suitable types of applications.

From the foregoing, it will be appreciated that specific embodiments of the technology have been described herein for purposes of illustration, but that various modifications may be made without deviating from the disclosed technology. Elements of one embodiment may be combined with other embodiments in addition to or in lieu of the elements of the other embodiments. Accordingly, the technology is not limited except as by the appended claims.

I/We claim:

1. A switching mode power supply, comprising:
a switching circuit coupled between an input voltage and ground;
an inductor coupled to the switching circuit, the inductor being configured to supply an output voltage to a load;
a voltage feedback circuit coupled to the inductor, the voltage feedback circuit being configured to generate an error signal based on a comparison of the output voltage of the inductor and a reference voltage;
a pulse width modulation (PWM) controller operatively coupled to the switching circuit, the PWM controller being configured to modulate a duty cycle of the switching circuit to charge the inductor based at least in part on the error signal from the voltage feedback circuit; and
an oscillator having an oscillator input coupled to the voltage feedback circuit and an oscillator output coupled to the PWM controller, the oscillator being configured to receive the error signal at the oscillator input and supply a clock signal to the PWM controller based on the received error signal.

2. The switching mode power supply of claim 1 wherein:
the switching circuit includes a first switch and a second switch;
the first switch has a first source, a first drain, and a first gate;
the second switch has a second source, a second drain, and a second gate;
the PWM controller has a first output and a second output;
the first source of the first switch is coupled to the input voltage;
the first drain of the first switch is coupled to the second source of the second switch and to the inductor;
the second drain of the second switch is coupled to the ground;
the first gate of the first switch is coupled to the first output of the PWM controller;
the second gate of the second switch is coupled to the second output of the PWM controller;
the switching mode power supply further includes:
a capacitor in parallel to the load and coupled to the inductor;
a current comparator coupled to the voltage feedback circuit and the input voltage, the current comparator being configured to generate a control signal based on the error signal and a switch current flowing through the first and second switches and supply the generated control signal to the PWM controller.
the PWM controller is configured to modulate a duty cycle of the first and second switches based on the control signal and the clock signal.

3. The switching mode power supply of claim 1 wherein the oscillator includes:
a charging switch having a source, a drain, and a gate, the source being coupled to the error signal;
an oscillation capacitor having a first end coupled to the drain of the charging switch and a second end coupled to the ground;
an oscillation current source coupled in parallel to the oscillation capacitor;
an oscillator comparator having a first terminal coupled to the first end of the oscillation capacitor, a second terminal, and an output terminal;
an one-shot circuit having an input coupled to the output terminal of the oscillator comparator and an output coupled to the gate of the charging switch and the oscillator output; and
a divider resistor having a first end coupled to the error signal and a second end coupled to the second terminal of the oscillator comparator.

4. The switching mode power supply of claim 1 wherein the oscillator includes:
a charging switch having a source coupled to the error signal, a drain; and a gate;
an oscillation capacitor having a first end coupled to the drain of the charging switch and a second end coupled to the ground;
an oscillator comparator having a first terminal coupled to the first end of the oscillation capacitor, a second terminal, and an output terminal coupled to the gate of the charging switch; and
a divider resistor having a first end coupled to the error signal and a second end coupled to the second terminal of the oscillator comparator.

5. The switching mode power supply of claim 1 wherein the oscillator includes:
an oscillation capacitor coupled to the error signal;
an oscillator comparator having a first terminal coupled to the oscillation capacitor and a second terminal; and
a divider resistor coupled between the error signal and the second terminal of the oscillator comparator.

6. The switching mode power supply of claim 1 wherein the oscillator includes:
an oscillation capacitor;
an oscillator comparator having a first terminal coupled to the oscillation capacitor and a second terminal; and
a divider resistor coupled between the error signal and the second terminal of the oscillator comparator.

7. The switching mode power supply of claim 1 wherein the oscillator includes:
a charging switch having a source, a drain, and a gate, the source being coupled to a supply voltage and the drain being coupled to the error signal;
an oscillation capacitor having a first end coupled to the source of the charging switch and a second end coupled to ground;
an oscillation current source coupled in series with the oscillation capacitor;
an oscillator comparator having a first terminal, a second terminal, and an output terminal, the first terminal being coupled to the first end of the oscillation capacitor;
an one-shot circuit having an input coupled to the output terminal of the oscillator comparator and an output coupled to the gate of the charging switch; and
a divider resistor having a first end coupled to the second terminal of the oscillator comparator and a second end coupled to the error signal.

8. The switching mode power supply of claim 1 wherein the oscillator includes:
a charging switch;
an oscillation capacitor having a first end coupled to the charging switch and a second end coupled to the ground;
an oscillator comparator having a first terminal, a second terminal, and an output terminal, the first terminal being coupled to the first end of the oscillation capacitor and the output terminal being coupled and configured to control the charging switch; and
a divider resistor having a first end coupled to the second terminal of the oscillator comparator and a second end coupled to the error signal.

9. The switching mode power supply of claim 1 wherein the oscillator includes:
an oscillation capacitor having a first end controllably coupled to the error signal and a second end coupled to the ground;
an oscillator comparator having a first terminal and a second terminal, the first terminal being coupled to the first end of the oscillation capacitor; and
a divider resistor having a first end coupled to the second terminal of the oscillator comparator and a second end coupled to the error signal.

10. The switching mode power supply of claim 1 wherein the oscillator includes:
a divider resistor;
an oscillation capacitor controllably coupled between the error signal and the ground; and
an oscillator comparator having a first terminal and a second terminal, the first terminal being coupled to the oscillation capacitor and the second terminal being coupled to the error signal by the divider resistor.

11. The switching mode power supply of claim 1 wherein the oscillator includes:
a charging switch having a source, a drain, and a gate, the source being coupled to a supply voltage and the drain being coupled to the ground;
an oscillation capacitor having a first end coupled to the source of the charging switch and a second end coupled to ground;
an oscillation current source coupled to the first end of the oscillation capacitor;
an oscillator comparator having a first terminal, a second terminal, and an output terminal, the first terminal being coupled to the first end of the oscillation capacitor and the second terminal being coupled to a generally constant oscillation reference voltage;
an one-shot circuit having an input coupled to the output terminal of the oscillator comparator and an output coupled to the gate of the charging switch;
a current setting circuit coupled to the error signal, the current setting circuit being configured to generate a current level corresponding to the error signal; and
a current mirror configured to duplicate the generated current level in the current setting circuit in the oscillation current source.

12. The switching mode power supply of claim 1 wherein the oscillator includes:
an oscillation capacitor;
an oscillation current source coupled to the oscillation capacitor;
an oscillator comparator having a first terminal, a second terminal, and an output terminal, the first terminal being coupled to the oscillation capacitor and the second terminal being coupled to a generally constant oscillation reference voltage;
a current setting circuit coupled to the error signal, the current setting circuit being configured to generate a current level corresponding to the error signal; and
a current mirror configured to duplicate the generated current level in the current setting circuit in the oscillation current source.

13. A switching mode power supply, comprising:
a switching circuit;
an inductor coupled to the switching circuit, the inductor being configured to supply an output voltage to a load;
a pulse width modulation (PWM) controller operatively coupled to the switching circuit, the PWM controller being configured to modulate a duty cycle of the switching circuit to charge the inductor; and
an oscillator coupled to the PWM controller, the oscillator being configured to generate a clock signal based at least in part on the output voltage at the inductor and supply the generated clock signal to the PWM controller to modulate the duty cycle of the switching circuit.

14. The switching mode power supply of claim 13 wherein the oscillator includes:
an oscillation capacitor;
a divider resistor; and
an oscillator comparator having a first terminal coupled to the oscillation capacitor and a second terminal coupled to the output voltage via the divider resistor.

15. The switching mode power supply of claim 13, further comprising a voltage feedback circuit coupled to the inductor, the voltage feedback circuit being configured to generate an error signal based on a comparison of the output voltage of the inductor and a reference voltage, wherein the oscillator includes:
an oscillation capacitor;
an oscillator comparator having a first terminal coupled to the oscillation capacitor and a second terminal; and
a divider resistor coupled between the error signal and the second terminal of the oscillator comparator.

16. The switching mode power supply of claim 13, further comprising a voltage feedback circuit coupled to the inductor, the voltage feedback circuit being configured to generate an error signal based on a comparison of the output voltage of the inductor and a reference voltage, wherein the oscillator includes:
a divider resistor;
an oscillation capacitor controllably coupled between the error signal and a ground; and
an oscillator comparator having a first terminal and a second terminal, the first terminal being coupled to the oscillation capacitor and the second terminal being coupled to the error signal by the divider resistor.

17. The switching mode power supply of claim 13, further comprising a voltage feedback circuit coupled to the inductor, the voltage feedback circuit being configured to generate an error signal based on a comparison of the output voltage of the inductor and a reference voltage, wherein the oscillator includes:
an oscillation capacitor;
an oscillation current source coupled to the oscillation capacitor;
a current setting circuit coupled to the error signal, the current setting circuit being configured to generate a current level corresponding to the error signal; and
a current mirror configured to duplicate the generated current level in the current setting circuit in the oscillation current source.

18. A method of operating a switch mode power supply having a switching circuit coupled to an inductor, the method comprising:
modulating a duty cycle of the switching circuit to charge the inductor using pulse width modulation;
supplying an output voltage from the inductor to a load;
performing a comparison between the output voltage and a reference voltage;
deriving an error signal based on the comparison between the output voltage and the reference voltage; and
generating a clock signal for the pulse width modulation based on the received error signal.

19. The method of claim 18 wherein generating the clock signal includes:
deriving a comparison signal by dividing the error signal;
charging an oscillation capacitor with a voltage corresponding to the error signal in a first period;
discharging the oscillation capacitor in a second period;
comparing an instantaneous voltage of the oscillation capacitor to the comparison signal to generate the clock signal during the second period.

20. The method of claim 18 wherein generating the clock signal includes:
deriving a comparison signal by dividing the error signal;
charging an oscillation capacitor with a voltage corresponding to the error signal in a first period;
discharging the oscillation capacitor in a second period;
comparing an instantaneous voltage of the oscillation capacitor to the comparison signal; and
if the instantaneous voltage is higher than the comparison signal, generating a pulse as the clock signal.

21. The method of claim 18 wherein generating the clock signal includes:
deriving a comparison signal by dividing the error signal;
charging an oscillation capacitor with a voltage corresponding to the error signal in a first period;
discharging the oscillation capacitor in a second period;
comparing an instantaneous voltage of the oscillation capacitor to the comparison signal; and
if the instantaneous voltage is lower than the comparison signal, generating a pulse as the clock signal.

22. The method of claim 18 wherein generating the clock signal includes:
charging an oscillation capacitor in a first period;
discharging the oscillation capacitor with a current level in a second period;
setting the current level based on the error signal; and
comparing an instantaneous voltage of the oscillation capacitor to a generally constant oscillation reference voltage to generate the clock signal during the second period.

23. A switch mode power supply having a switching circuit coupled to an inductor configured to supply an output voltage to a load, the switch mode power supply comprising:
means for modulating a duty cycle of the switching circuit to charge the inductor using pulse width modulation;
means for performing a comparison between the output voltage of the inductor and a reference voltage and for deriving an error signal based on the comparison between the output voltage and the reference voltage; and
means for generating a clock signal for the pulse width modulation based on the received error signal.

24. The switch mode power supply of claim 23 wherein the means for generating the clock signal includes:
means for deriving a comparison signal by dividing the error signal;
means for charging an oscillation capacitor with a voltage corresponding to the error signal in a first period;
means for discharging the oscillation capacitor in a second period; and
means for comparing an instantaneous voltage of the oscillation capacitor to the comparison signal to generate the clock signal during the second period.

25. The switch mode power supply of claim 23 wherein the means for generating the clock signal includes:
means for charging an oscillation capacitor in a first period;
means for discharging the oscillation capacitor with a current level in a second period;
means for setting the current level based on the error signal; and
means for comparing an instantaneous voltage of the oscillation capacitor to a generally constant oscillation reference voltage to generate the clock signal during the second period
